(19) United States
(12) Patent Application Publication
(10) Pub. No.: US 2012/0325971 A1
(43) Pub. Date: Dec. 27, 2012

(54) Space vacuum propulsion system

(76) Inventor: Darrell Eugene Heard, Washington, DC (US)

(21) Appl. No.: 13/506,619

(22) Filed: Apr. 6, 2012

Related U.S. Application Data
(60) Provisional application No. 61/626,241, filed on Sep. 23, 2011.

(51) Int. Cl. B64G 1/40

(52) U.S. Cl. 244/171.1

(57) ABSTRACT

This propulsion system is based on the theory of vacuum propulsion wherein a propulsion System utilizes space vacuum to propel the space ship through space. Vacuum Pumps are used to vacuum in space through the rear of the ship where it is gathered or collected in a pressure chamber. There the collected space is contained while yet more space vacuum is collected. The chamber has a containment valve at the end of the chamber and can be breached after vacuum collected reaches critical mass overcoming the containment valve where it is then released into the hull. This release of the vacuum chamber containment valve and the collected vacuum oozes from the vacuum chamber filling the hull mixing with carbon dioxide and heat changing the nature of space vacuum and creating a propellant fuel for propulsion. The chamber is situated at the rear of the starship.

### REFERENCE TO A SEQUENCE LISTING, TABLE, OR A COMPUTER, LISTING COMPACT DISC APPENDIX

N/A

### SEQUENCE LISTING

N/A

### INVENTOR

DARRELL E. HEARD

APPLICATION 626,241 PROVISIONAL PATENT

FILED: Sep. 23, 2011 FORIEGN FILING DATE: Oct. 17, 2011

### CROSS REFERENCE TO RELATED APPLICATIONS

N/A

### STATEMENT REGARDING FEDERALLY SPONSORED RESEARCH OR DEVELOPMENT

N/A

### TITLE: SPACE VACUUM PROPULSION SYSTEM

Preliminary class

### CROSS REFERENCE TO RELATED APPLICATIONS

N/A

### STATEMENT REGARDING FEDERALLY SPONSORED RESEARCH OR DEVELOPMENT

### DESCRIPTION OF THE SEVERAL VIEWS OF THE DRAWINGS

This is an amendment to the specification to insert the following language as the first paragraph of the brief description of the drawings:

The patent or application file contains at least one drawing executed in color. Copies of this patent or patent application publication with color drawing(s) will be provided by the Office upon request and payment of the necessary fee. This is an amendment to the specification submitted On Jun. 6, 2012 and includes some new specifications.

FIG. 1 VACUUM TRANSFER PUMP at 1 connects to FIG. 26 at 2. FIG. 26 at 1 connects to hull or a vent leading to space vacuum conduction. FIG. 1 at 2 connects to FIG. 18 at 1. FIG. 18 at 2 connects to no. 1 on FIG. 12. FIG. 1 at 3 is 1 by and connects to pole 1 on FIG. 10. FIG. 1 at 4 is 2 bk connects to the vacuum pump relay FIG. 10 at pole 2. FIG. 1 at electrical contact 5 connects to 3 or 1 bk and FIG. 1 at electrical contact 6 connects to FIG. 10 at 4 or 2 bk respectively.

FIG. 2 VACUUM TRANSFER PUMP at 1 connects to FIG. 27 at 1. FIG. 27 at 1 connects to ships' hull. FIG. 2 at 2 connects to FIG. 19 at 1. FIG. 19 connects at 2 to FIG. 12 at 2. FIG. 2 at 3 is 1 bk and connects to pole 3 on FIG. 10.

FIG. 2 at 4 is 2 bk connects to the vacuum pump relay FIG. 10 at pole 4

FIG. 2 at electrical contact 5 connects to 3 or 1 bk and FIG. 2 at electrical contact 6 connects to FIG. 10 at 4 or 2 bk respectively.

FIG. 3 VACUUM TRANSFER PUMP is a perspective view a Transfer vacuum pump utilized in the system. Its' location is on the side left of the Pressurized vacuum chamber.

FIG. 3 at 3 is 1 bk and connects to pole 1 on FIG. 11. FIG. 3 at 4 is 2 bk connects to the vacuum pump relay FIG. 11 at pole 2. FIG. 3 at electrical contact 5 connects to 1 bk or 3 and FIG. 3 at electrical contact 6 connects to 2 bk or 4.

FIG. 3. at 1 is connected to FIG. 34 at 2.

FIG. 4 SAIL Is a sail utilized by the system. Its' location is in the front of the ship inside the hull secured to the first section of the hull mast.

FIG. 5 SAIL Is a sail utilized by the system. Its' location is in the front of the ship secured to the second section hull mast.

FIG. 6 SAIL Is a sail utilized by the system. Its' location is in the front of the ship aligned with FIG. 5 secured to the third mast of the hull.

FIG. 7 SAIL Is a sail utilized by the system. Its' location is in the front of the ship aligned with FIG. 6 secured to the fourth section of the hull mast.

FIG. 8 SAIL Is a sail utilized by the system. Its' location is in the front of the ship aligned with FIG. 7 inside the hull secured to the fifth section of the hull mast.

FIG. 9 SAIL Is a sail utilized by the system. Its' location is in the front of the ship aligned with FIG. 8 secured to the sixth section of the hull mast.

FIG. 10. VACUUM PUMP RELAY No. 1 connects to FIG. 1 and FIG. 2

FIG. 11. VACUUM PUMP RELAY No. 2 connects to FIG. 3 and FIG. 13

FIG. 12 VACUUM CHAMBER is a Vacuum chamber capable of holding space vacuum and co2 gases up to a combined volume of up to 34000 cubic feet with a preliminary psi pressure exertion threshold of 800 psia and meeting all requirements of 220 psi for co2 containment. There may need to be some small modification for the purposes of transference and containment of co2 gas in combination with space vacuum because of the weightless environment of the universe. FIG. 12. at 1 connects to FIG. 18 at 1 and FIG. 19 at 1 connects at 2 on FIG. 12.

FIG. 13 at 3 is attached to FIG. 12 at 3.

FIG. 13 CO2 COMPRESSOR Co2 compressor sets near approximate of FIG. 10 on the intake side of FIG. 12 FIG. 13 at 1 connects to pole 3 on FIG. 11. FIG. 13 at 2 connects to pole 4 on FIG. 11. FIG. 13 at 3 connects to compressor hose FIG. 32 at 1. FIG. 21 at 2 connect as imput into vacuum chamber at 3. FIG. 13 at 5, 6, 7 and 8 connects to FIG. 36 at 1, 2, 3, and 4

FIG. 14 CO2 GAS STORAGE TANK NO. 1 Co2 gas storage Tank no. 1 at 1 attaches to FIG. 30 at 1. FIG. 14 at 5, 6, 7, 8, 9 and 10 attaches to FIG. 28 at 1, 2, 3, 4, 5, and 6

FIG. 15 CO2 GAS STORAGE TANK NO. 2 Co2 gas storage Tank no. 2 at 1 attaches to FIG. 31 at 1 and is an insert into FIG. 20 at 2. FIG. 15 at 5, 6, 7, 8, 9 and 10 attaches to FIG. 29 at 1, 2, 3, 4, 5, and 6

FIG. 16 VACUUM CHAMBER SERVO MOTOR RELAY BOX No. 1 connects to FIG. 21 at 1 and 2

FIG. 17 VACUUM CHAMBER SERVO MOTOR RELAY BOX No. 2 connects to FIG. 24 at 1 and 2

FIG. 18 VACUUM TRANSFER PUMP LINE AND CHAMBER INTAKE VALVE No. 1 FIG. 18 at 1 is connected to FIG. 1 at 2. FIG. 18 at 2 of the Transfer pump line and vacuum chamber intake check valve 1 is connected to FIG. 12 at 1.

FIG. 19 VACUUM TRANSFER PUMP LINE AND CHAMBER INTAKE VALVE NO. 2 Transfer pump line and chamber intake check valve 2 FIG. 19 at 1 is connected to FIG. 1 at 2. FIG. 19 at 2 of the Transfer pump line and vacuum chamber intake check valve 1 is connected to FIG. 12 at 2.

FIG. 20 T-CONNECTOR CONDUIT PIPE T-Connection Conduit pipe FIG. 20 at 3 connects to carbon dioxide compressor FIG. 13 at 1. The compressor is located in the front of the vacuum chamber near the service door. FIG. 20 at 1′ connects to FIG. 30 at 1. and FIG. 20 at 2. connects to FIG. 31 at 2.

FIG. 21 VACUUM CHAMBER/3 PHASE ACTUATING MOTOR/GEAR Vacuum Chamber/3 phase servo actuating motor/gear at 2 is connected to FIG. 23. at 1 and is used to activate the Vacuum chamber aperture lever FIG. 23 at 3.

FIG. 22 CO2 VALVE. Valve head at 2 is inserted into vacuum chamber at 3. Valve tail at 1 is connected to compressor hose FIG. 32 at 2.

FIG. 23 VACUUM CHAMBER APERTURE ASSEMBLY Vacuum chamber aperture assembly connects to FIG. 21 at 1.

FIG. 24 FRONT HULL APERTURE/3 PHASE ACTUATING MOTOR/GEAR Front hull aperture/3 phase servo actuating motor/gear at 2 is connected to FIG. 33 at 1 and is used to activate the vacuum chamber aperture lever FIG. 33 at 3

FIG. 25 HEAT TRANSFER SYSTEM FIG. 32 at 1 and 2 are connected to a central controller, not shown. FIG. 25 at 3 is the release button to the heating conduit at 7. FIG. 25 at 4 is hull heat. FIG. 25 at 5 is CO2 jacket heat at FIG. 14 at 2 coupling FIG. 25 at 6 is jacket heat at FIG. 15 at 2 coupling.

FIG. 26 TRANSFER VACUUM PUMP INTAKE NO. 1 is connected to FIG. 1 at 2.

FIG. 26 at 1 connects to ships' hull.

FIG. 27. TRANSFER PUMP INTAKE No. 2 is connected to FIG. 1 at 2.

FIG. 27 at 1 connects to ships' hull. FIG. 27 at 1 connects to hull or vent leading to space vacuum conduction.

FIG. 28 LEFT MOUNT CO2 TANK/Right mount carbon dioxide tank is connected to FIG. 14 at 1, 2, 3, 4, 5, and 6 WING SCREWS.

FIG. 29. RIGHT MOUNT CO2 TANK Right mount carbon dioxide tank is connected to FIG. 15 at 1, 2, 3, 4, 5, and 6 WING SCREWS.

FIG. 30. CO2 REGULATOR/ELECTRONIC TIMER ASSEMBLY No. 1 at 1 is connected to FIG. 14 at 1. FIG. 30 at 2 is connected to FIG. 20 at 1. FIG. 30 is an insert into FIG. 20 at 1.

FIG. 31 CO2 REGULATOR/ELECTRONIC TIMER ASSEMBLY No. 2 at 1 is connected to FIG. 15 at 1. FIG. 31 at 2 is connected to FIG. 20 at 2. FIG. 31 is an insert into FIG. 20 at 1.

FIG. 32 COMPRESSOR HOSE is connected to co2 compressor FIG. 13 at 2

FIG. 33 FRONT HULL APERTURE ASSEMBLY Front hull aperture is connected to 24 at 1

FIG. 34. TRANSFER VACUUM PUMP INTAKE No. 3 Transfer pump intake is connected to FIG. 3 at 1. FIG. 34 attaches to ships' hull and assist in emergency vacuum assimilation.

FIG. 35 VACUUM TRANSFER PUMP LINE AND CHAMBER INTAKE VALVE No. 3. Transfer Pump swivel inlet is connected to FIG. 3 at 2. FIG. 35 is connected to the intake side of the vacuum chamber FIG. 12.at 3.

FIG. 36 CARBON DIOXIDE COMPRESSOR MOUNT Carbon dioxide compressor mount at 1, 2, 3, and 4 connects to FIG. 13.at 5, 6, 7 and 8.

FIG. 37. VACUUM TRANSFER PUMP No. 3 MOUNT Transfer Pump Mount is connected to the hull near front of vacuum chamber.

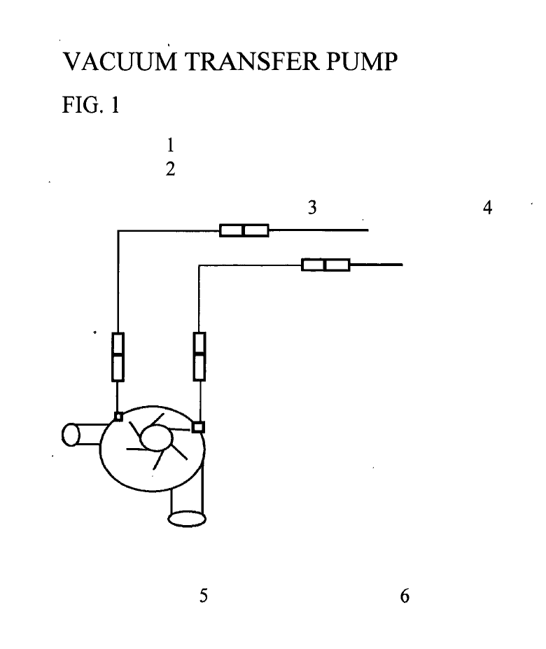

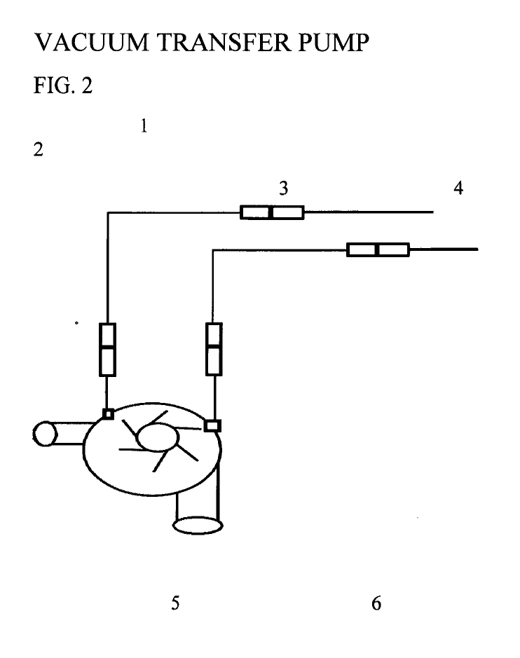

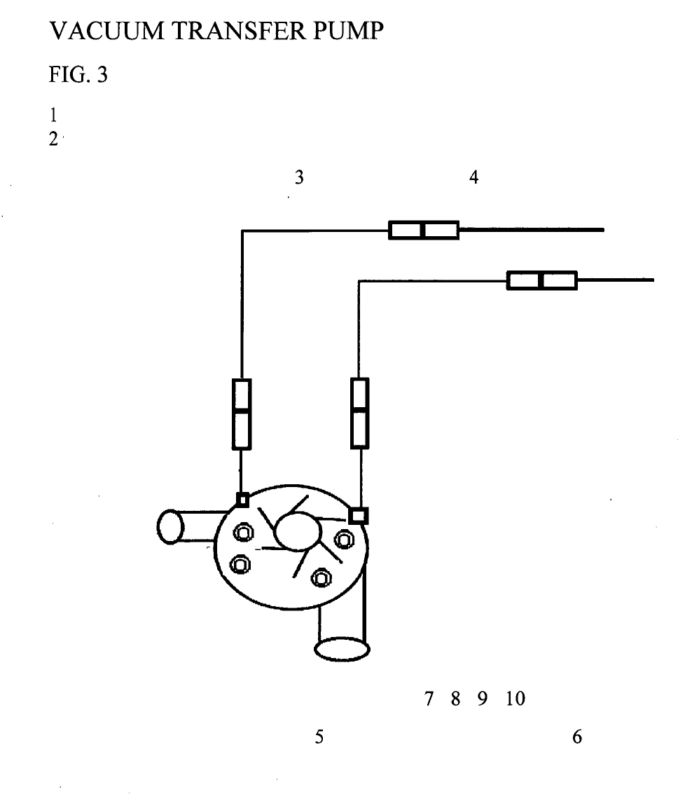

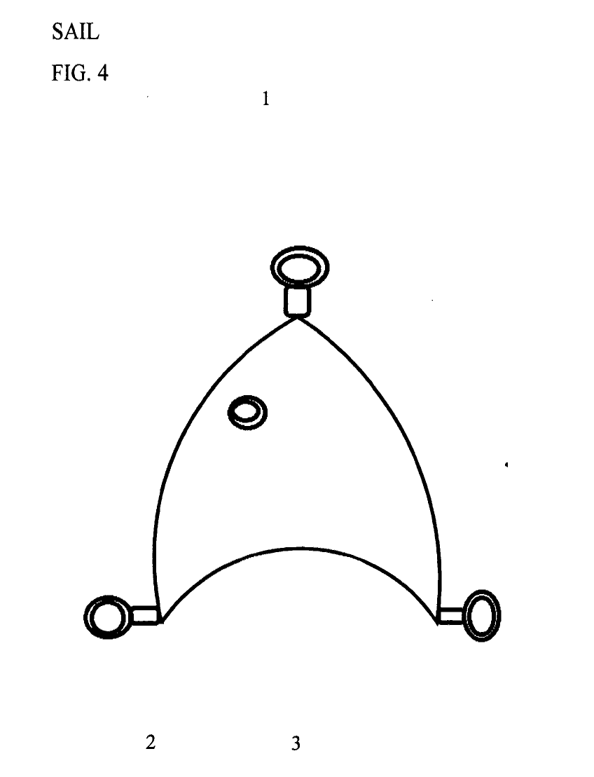

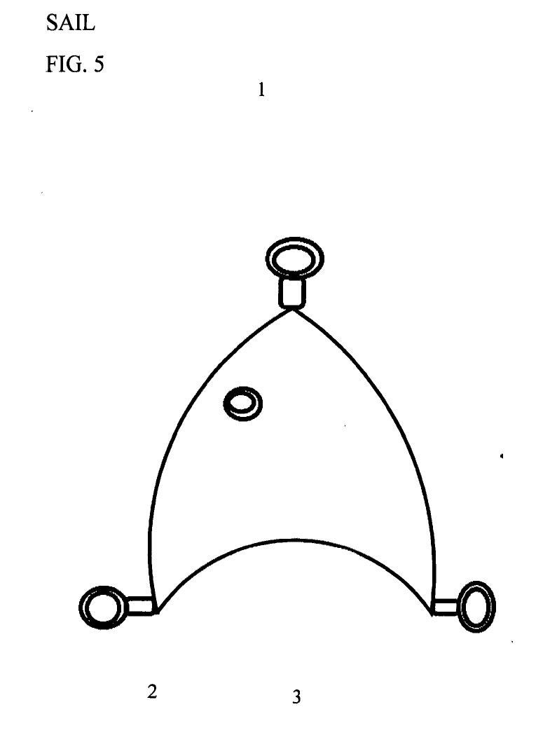

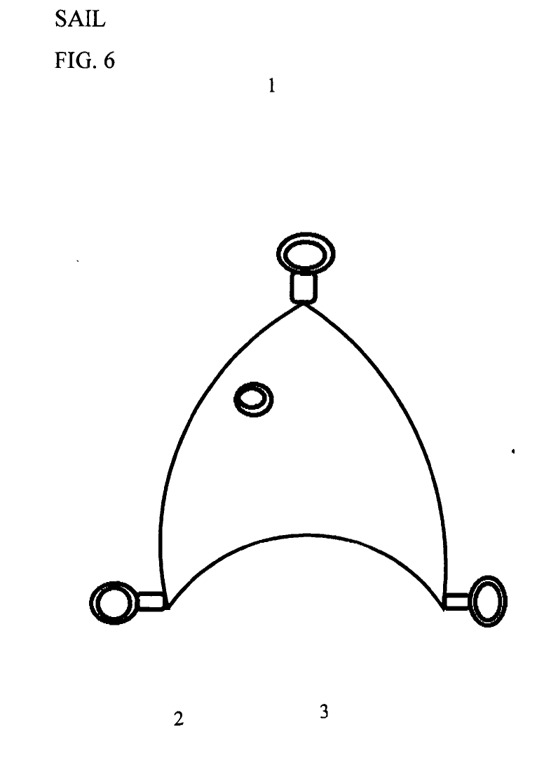

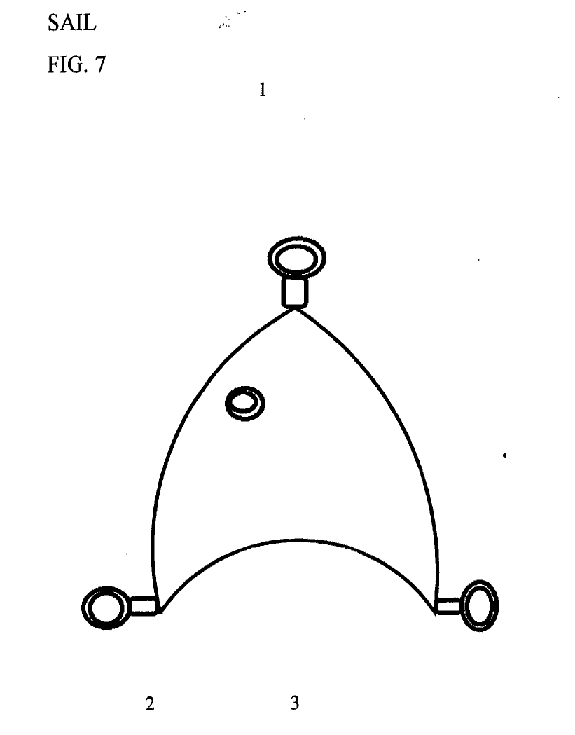

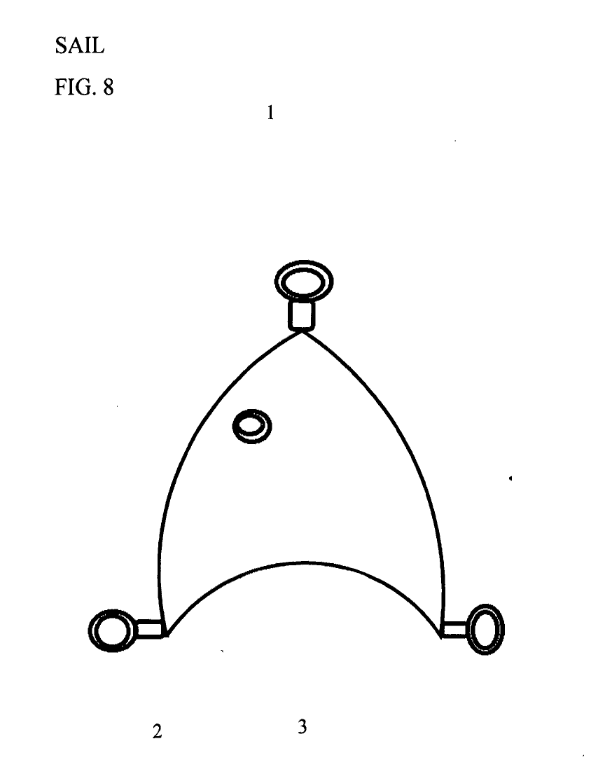

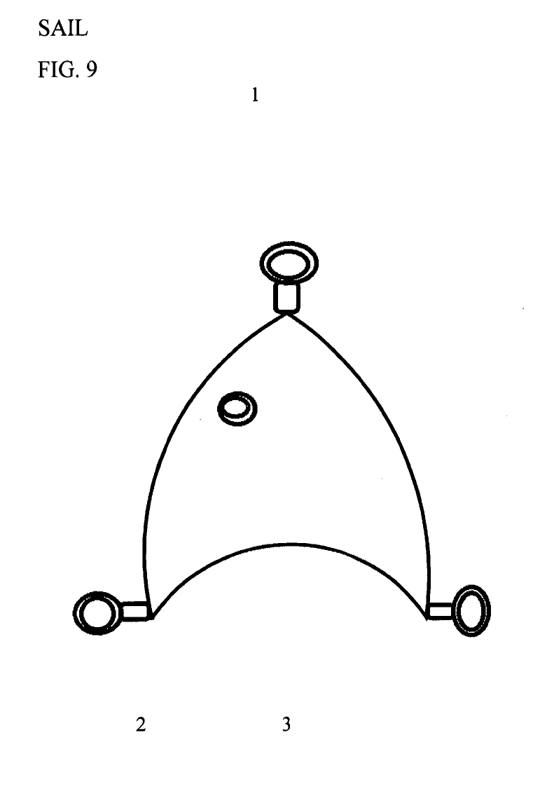

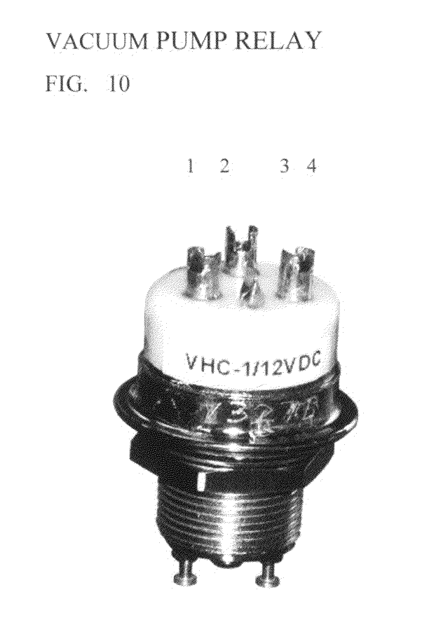

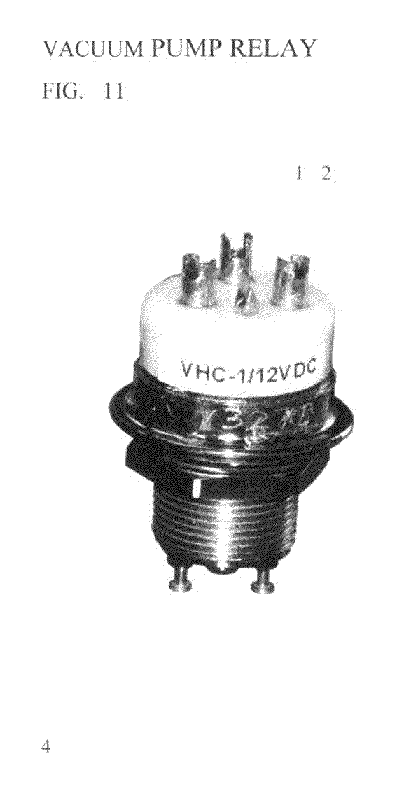

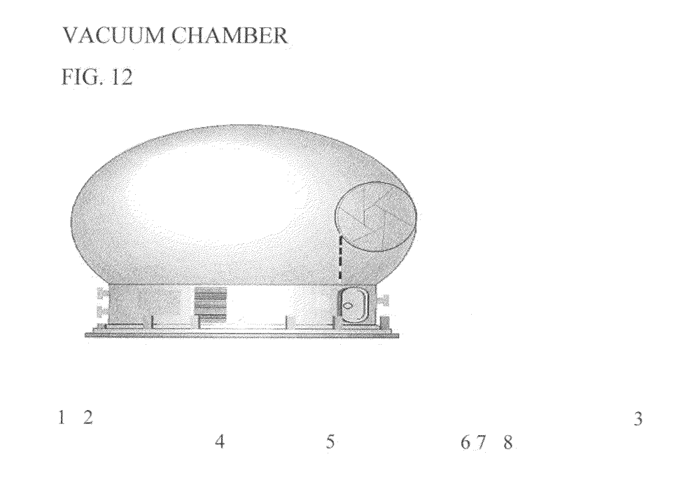

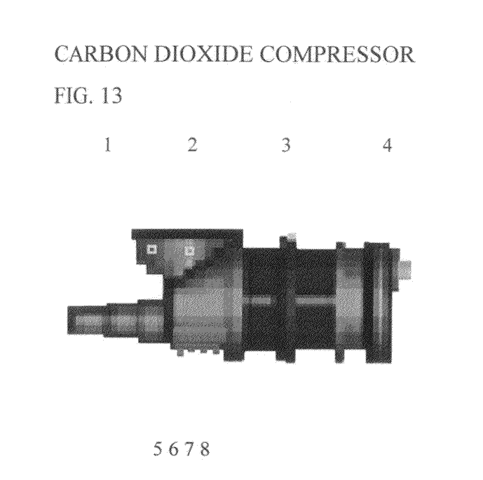

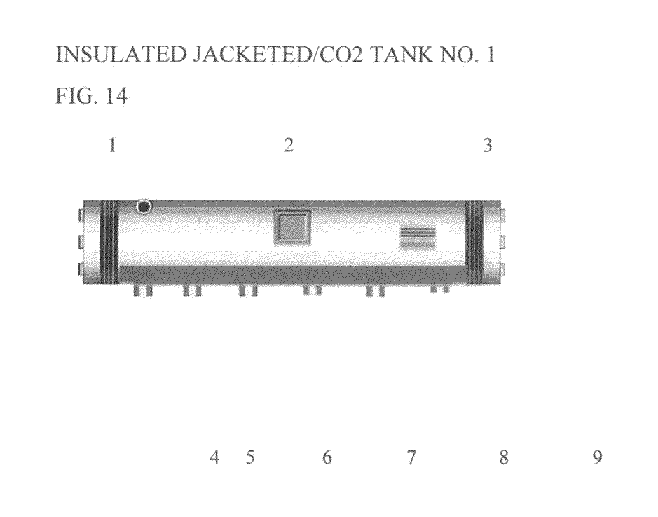

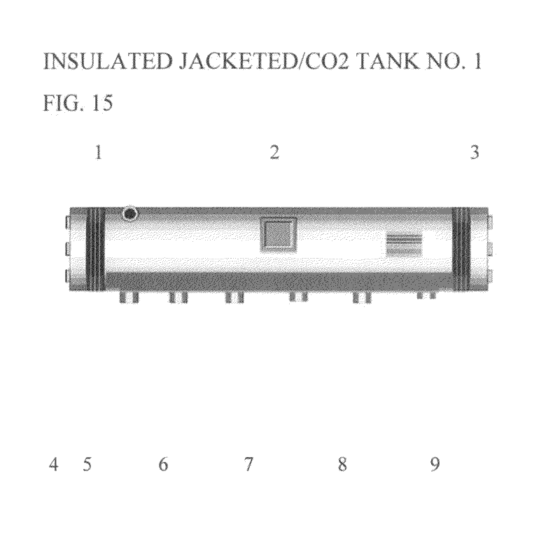

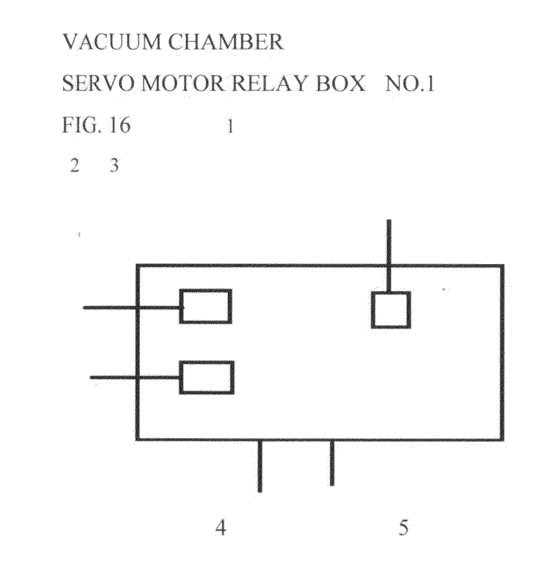

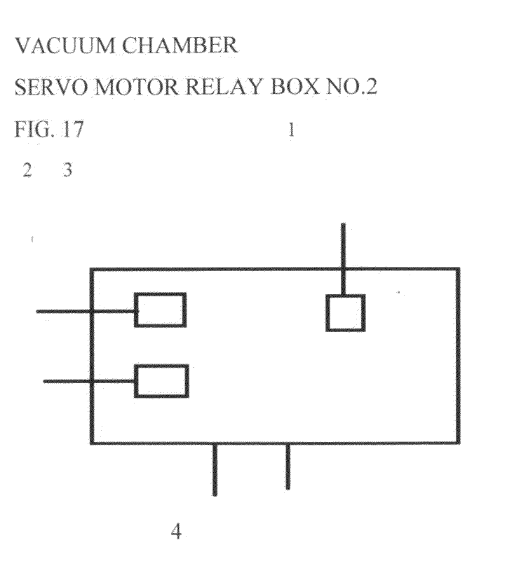

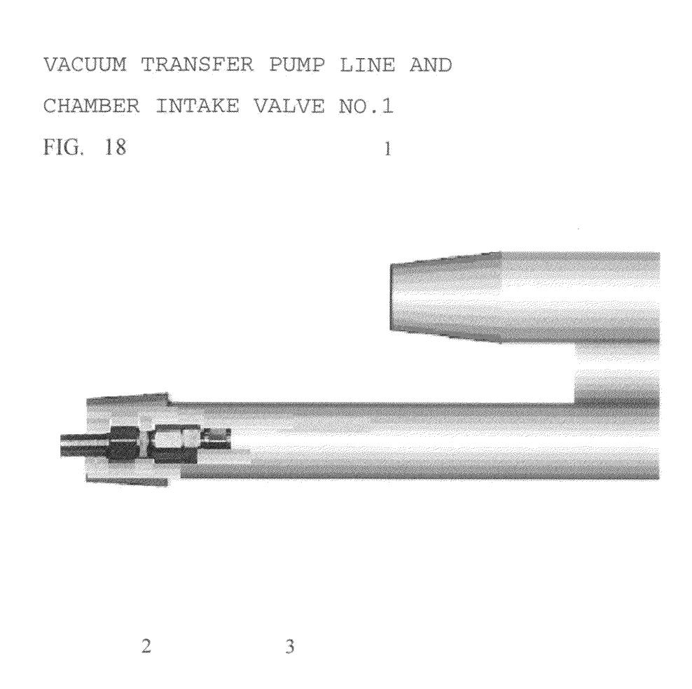

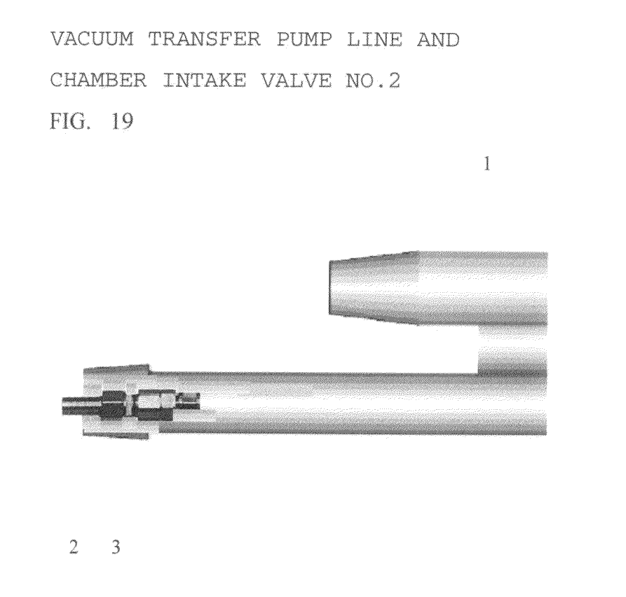

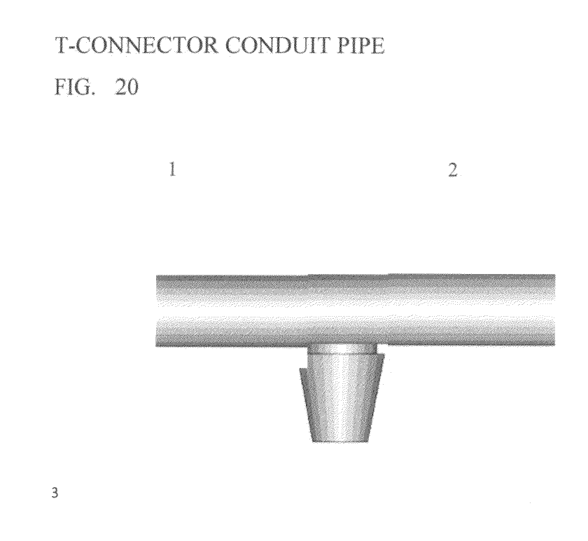

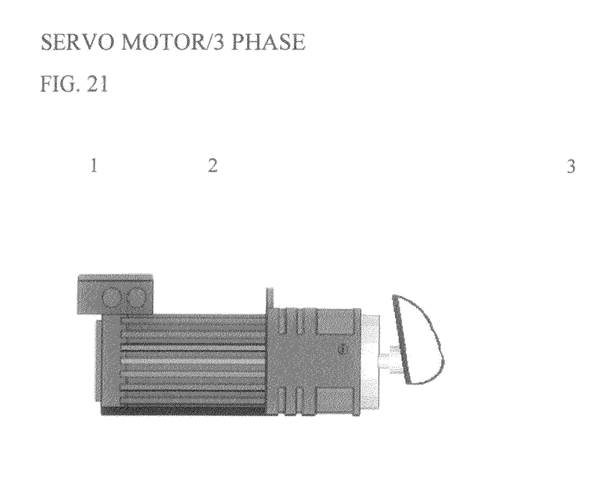

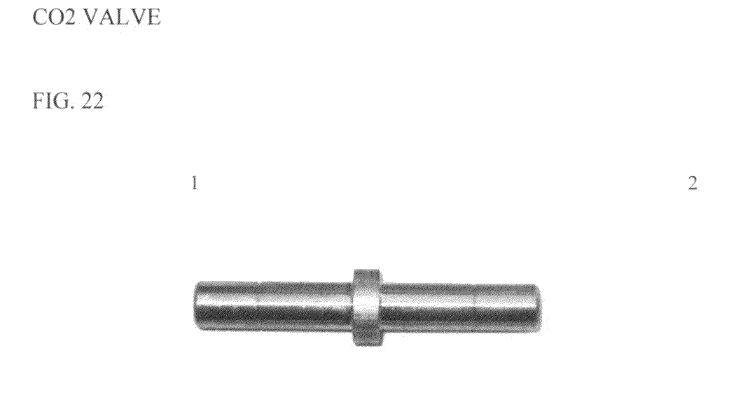

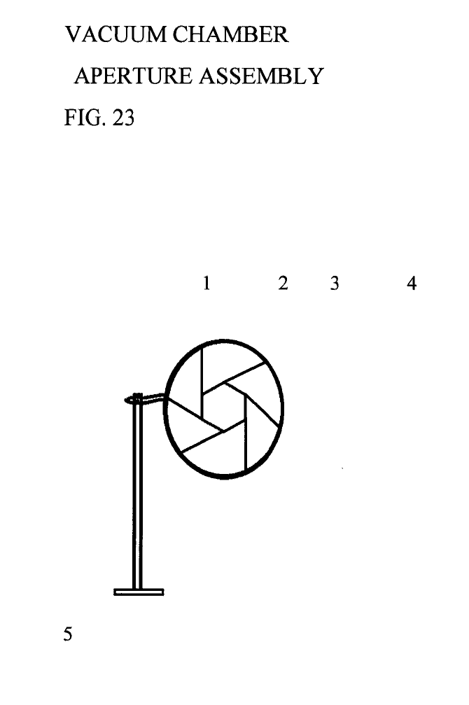

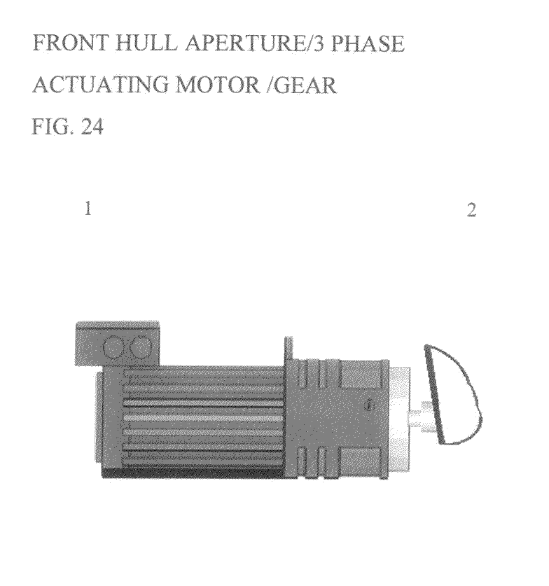

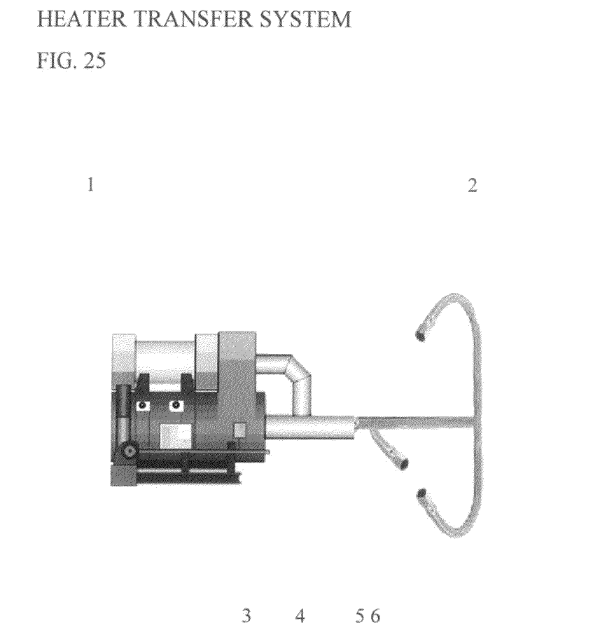

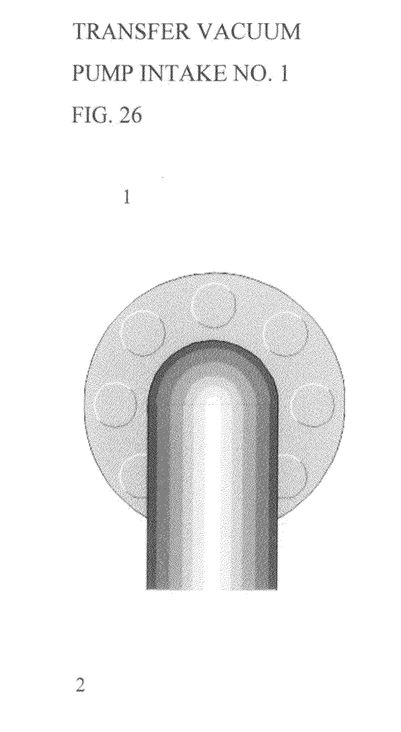

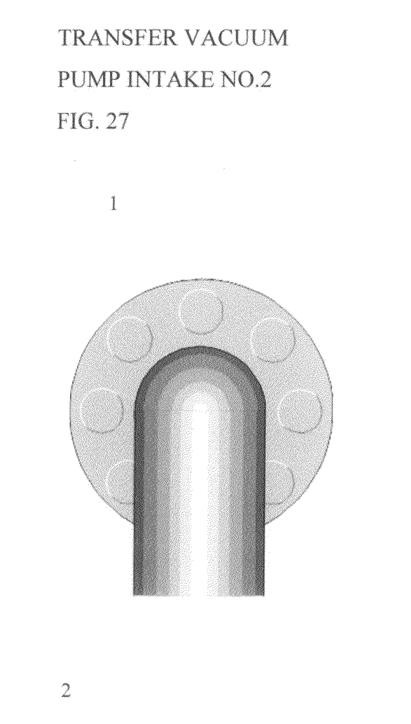

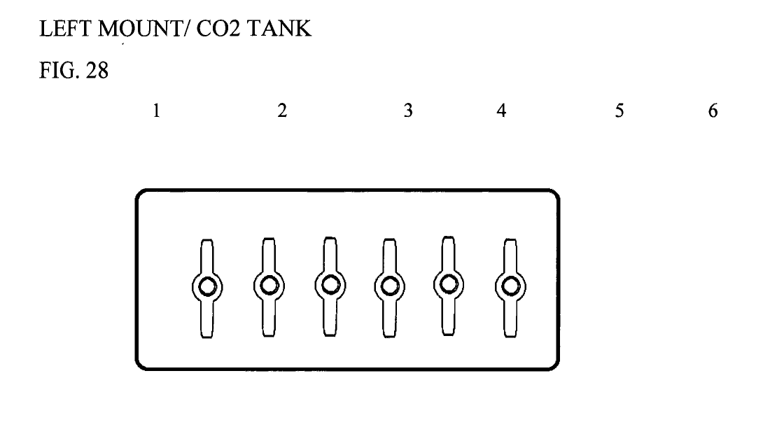

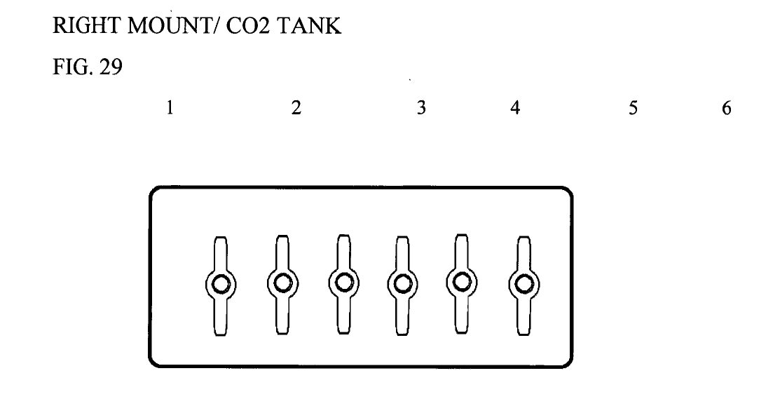

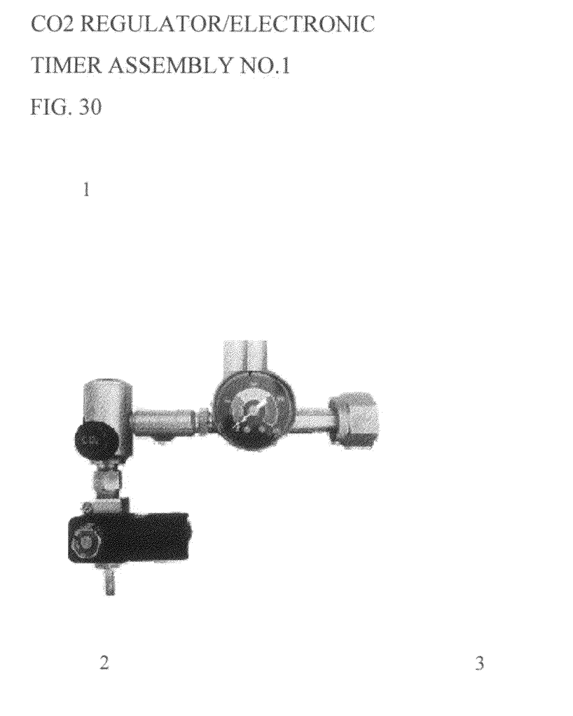

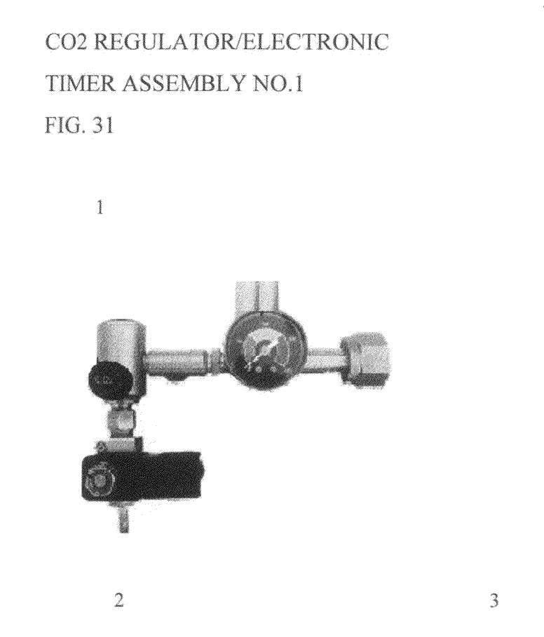

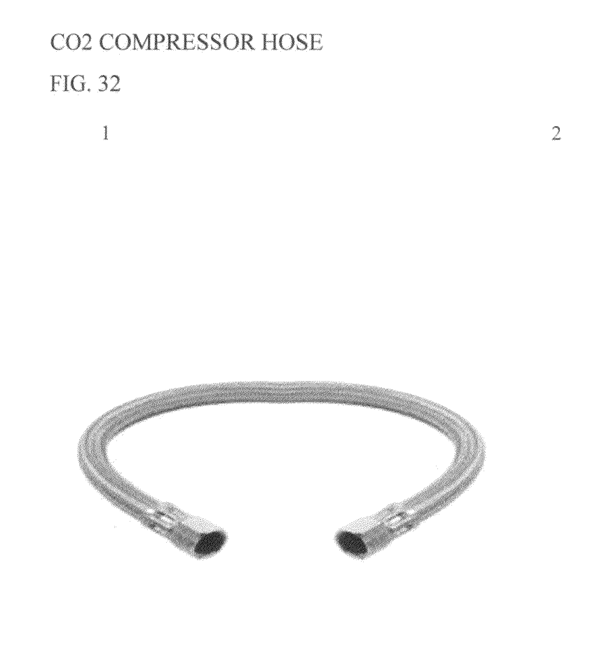

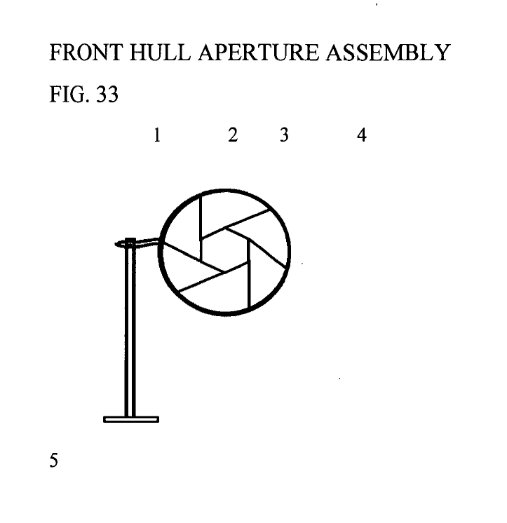

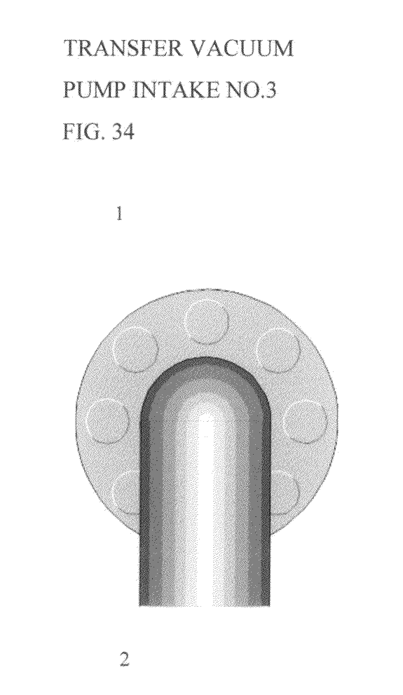

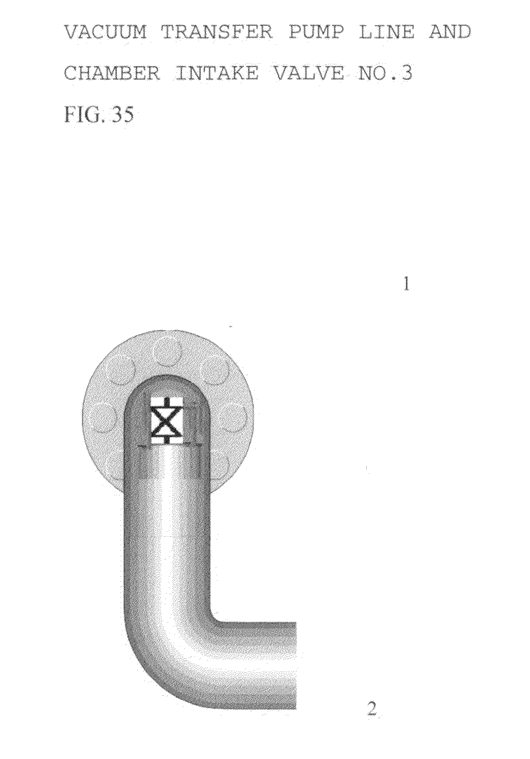

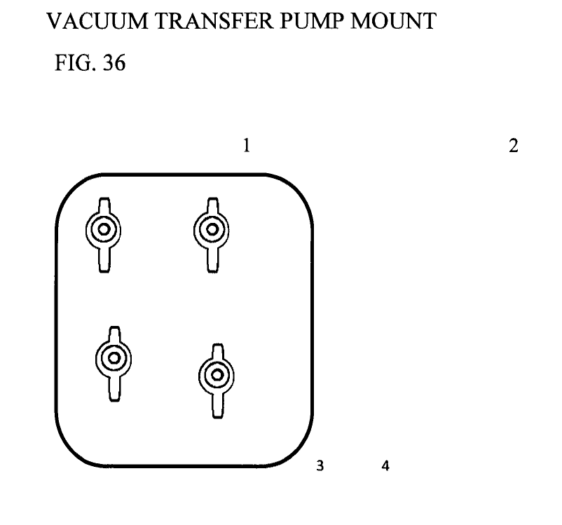

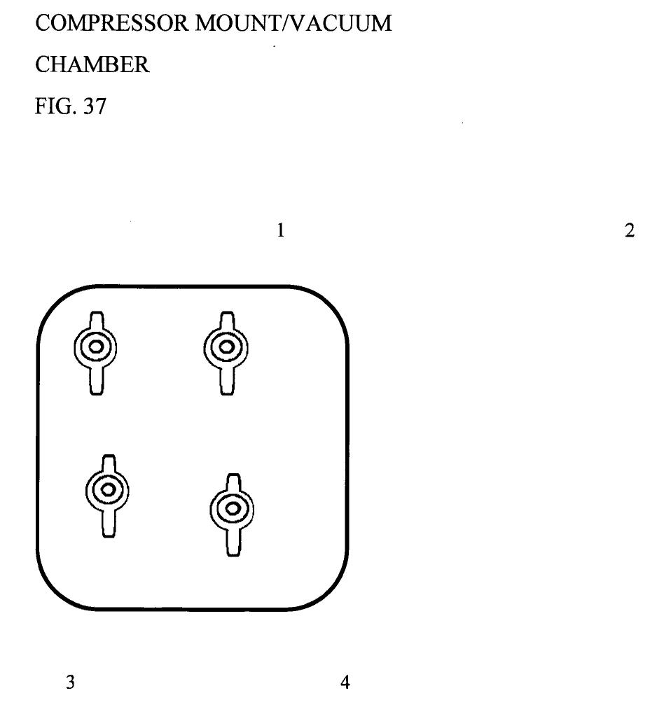

### DETAILED DESCRIPTION OF THE INVENTION

The Invention Begins with A pressurized chamber capable of holding space vacuum and co2 gases up to a combined volume of up to 34000 cubic feet with a preliminary psi pressure exertion threshold of 800 psia. and meeting all requirements of 220 psi for co2 containment. Equilibrium is attributed to hull construction which is also capable of outer space psi pressure exertions of 800 psia which shall also meet requirements for co2 gases in tank containment at minimum pressure of 200 psig 14 bar/1379 kPa for gaseous withdrawal. Electric pressure building vaporizers are inserted because of rapid withdrawal and constant flow of gases from the tank. Maximum operating and working thresholds are idea at Meeting OSHA standards but 0.05 percent concentration or threshold limit value of 5,000 parts per million must be exceeded in order to achieve proper turbulence velocity ratios.

Since the hull compartment will be uninhabitable by human beings exceeding this threshold limit value of 0.05 percent concentration can be achieved safely. Threshold limits value of co2 are calculated to be approximately 20 percent for proper turbulence velocity inside the hull and 20 percent for co2 threshold limits inside the pressure tank.

The tanks shall store carbon dioxide at 75 psia [60.4] psig(4 bar) The triple point. These tanks under operating conditions shall emit carbon dioxide into the chamber under conditions described in the previous paragraph. These tanks shall mix with space vacuum at a safe flow rate with the help of a compressor connected to the tanks for transfer of co2 from co2 storage tanks to the ships' pressure vacuum chamber where space vacuum shall already be present. This presence occurs because transfer pumps has accessed space vacuum through conduits and valves that have been placed on the skin of the vessel. These valves open and allow the transfer pumps to suction in space vacuum directly into the chamber. Thus the sequence of operation should occur as directed by an automated timing sequence via a computer controller. vacuum transfer pumps are initiated and begin the process of space vacuum transfer into the chamber. Once designated vacuum pressure is acquired vacuum transfer pumps cease and are deactivated. Simultaneously during that occurrence co2 tanks in combination with co2 valves and co2 compressor begin installing co2 gasses to their threshold pressure limits pursuant to the specifications of the vacuum chamber, tank and hull respectively. Once co2 containment is acquired in the tank the controller activates the Hulls' heater transfer system to increase hull temperature slightly to allow for proper transfer of co2 gasses from the chamber through the hull and to circulate heat through the jackets of the fuselage or around the co2 tanks to prevent freezing of co2 chemicals. In other words the co2 tanks are surrounded by an insulated jacket that allows for circulation of heat from the heat transfer system. (Not shown.). Servo motor relays which engage all servo motors which open the apertures in/on the vacuum chamber and apertures on the hull are also activated. The servo motors have three phases in which they can open 1/3rd during the 1st stage. 2/3rds during the second stage and finally 3/3rds during the final stage. These stages accommodate the decreases and increases in velocity and hull turbulence of co2 and space vacuum mixture and are used to control the amount of horsepower output of each sail inside the hull. Turbulent velocity against the sails becomes horsepower but the sails actually are ballooned at light speed since space vacuum can only move at light speed and no other lesser speed can be acquired by it. The limited opening of the apertures are what actually control the speed of the space vacuum propulsion systems' vehicles' motion forward. the ability of the sails to contain hull velocity of these chemicals is crucial to retaining horsepower.

What is claimed:

1. A space vacuum propulsion system wherein a propulsion system utilizes space vacuum to propel the space ship through space.

2. Transfer vacuum pumps or vacuum pumps used to suction in space through the outer hull of the ship where it is gathered or collected in a pressurized vacuum chamber.

3. The collection and containment of space vacuum inside a pressurized vacuum chamber or tank inside the hull of a space ship for the purpose of space propulsion.

4. Aperture doors at the end of the chamber that will allow vacuum collected to reach critical mass before releasing said vacuum into the hull.

5. Hull Aperture doors that will allow for co2 chemicals to be released into space

6. The filling of the hull with vacuum, carbon dioxide and heat or any other combination of chemicals or temperatures fluctuation used to change the nature of space vacuum in order to create a propellant fuel for vacuum propulsion.

7. The heater transfer system used to cause temperature fluctuations of the space vacuum inside the ships' hull.

8. The aperture doors in the front of the ship.

9. Aluminum alloy and steel meshed sails in the front of the hull inside the hull of a space ship or any combination of material used to effect a sail or sails whose location are inside the hull of a space craft

10. Compressor used to move co2 gasses other gasses into a chamber for the purposes of creating a propellant to be used in combination with space vacuum.

11. Carbon dioxide tanks or any chemical tank utilized to assist in the process for sole purpose of creating a propellant mixture made with space vacuum.
